(19) United States
(12) Patent Application Publication
(10) Pub. No.: US 2018/0370431 A1
(43) Pub. Date: Dec. 27, 2018

(54) UNATTENTED OCCUPANT PROTECTION SYSTEM (UOPS) SAFETY SYSTEM

(71) Applicant: AAMP of Florida, Inc., Clearwater, FL (US)

(72) Inventor: Nathaniel Lee Wincek, New Port Richey, FL (US)

(21) Appl. No.: 16/015,338

(22) Filed: Jun. 22, 2018

Related U.S. Application Data
(60) Provisional application No. 62/523,879, filed on Jun. 23, 2017.

(51) Int. Cl. B60Q 9/00; B60N 2/00; B60R 16/037; B60H 1/00; G01V 3/08; G01V 9/00; G01V 8/10; G01V 1/00; G10L 25/78; G10L 25/51

(52) U.S. Cl. CPC B60Q 9/00; B60N 2/002; B60R 16/037; B60H 1/00978; G01V 3/08; G01V 9/005; G10L 25/51; G01V 1/001; B60H 1/00742; B60H 1/00757; B60H 1/00778; G10L 25/78; G01V 8/10

(57) ABSTRACT

Aspects of the disclosure relate to apparatus and methods for unattended occupant protection system (UOPS) safety systems for passenger vehicles. The UOPS safety system may include a UOPS module. The module may be integrated with a vehicle data bus of the passenger vehicle. The module may be in communication with a plurality of UOPS sensors. The module may launch an equalization mode in response to determining, via the UOPS sensors, the presence of an unattended occupant in the passenger vehicle with a high or rising ambient temperature. The equalization mode may stabilize the ambient temperature of the passenger vehicle.

### CROSS-REFERENCE TO RELATED APPLICATION

This application is a non-provisional of U.S. Provisional Patent Application No. 62/523,879 filed Jun. 23, 2017 entitled “VEHICLE DATA FUSION IN UNATTENDED OCCUPANT PROTECTION SYSTEM” which is hereby incorporated by reference herein in its entirety.

### FIELD OF TECHNOLOGY

Aspects of the disclosure relate to passenger vehicle safety systems. Specifically, aspects of the disclosure relate to unattended occupant protection systems for ambient temperature equalization.

### BACKGROUND OF THE DISCLOSURE

Passenger vehicles are a ubiquitous form of travel. Passenger vehicles may carry a variety of occupants. An occupant may be elderly. An occupant may be a baby, toddler, or young child. An occupant may be physically frail. An occupant may be dependent on others for situational awareness and/or mobility.

There is a risk of a driver inadvertently leaving an occupant unattended in a parked vehicle. The occupant may be silent. The occupant may be sleeping. The driver may be accustomed to one routine that does not involve an occupant. When following a second routine that does involve an occupant, the driver may forget that the occupant is in the vehicle.

Temperatures inside a parked passenger vehicle can reach dangerous levels in relatively short periods of time. Within a few minutes of a passenger vehicle being parked in the hot summer sun, the ambient temperature inside a passenger vehicle can reach fatally high levels. In the winter as well, ambient temperatures in a passenger vehicle can reach dangerously low levels. If left unattended inside a passenger vehicle, an occupant may be in significant danger.

As such, it would be desirable to provide an unattended occupant protection system (UOPS) safety system for passenger vehicles. It would be further desirable to provide a UOPS safety system for equalizing the ambient temperature in a passenger vehicle. Moreover, it would be desirable to provide an UOPS safety system for aftermarket integration with passenger vehicles.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative information in accordance with principles of the disclosure;

FIG. 1A shows illustrative information in accordance with principles of the disclosure;

FIG. 1B shows illustrative information in accordance with principles of the disclosure;

FIG. 1C shows illustrative information in accordance with principles of the disclosure;

FIG. 2 shows an illustrative process in accordance with principles of the disclosure;

FIG. 3 shows another illustrative process in accordance with principles of the disclosure;

FIG. 4 shows an illustrative system in accordance with principles of the disclosure;

FIG. 5 shows an illustrative process in accordance with principles of the disclosure; and

FIG. 6 shows an illustrative system in accordance with principles of the disclosure.

### DETAILED DESCRIPTION OF THE DISCLOSURE

Apparatus and methods for unattended occupant protection system (UOPS) safety systems for passenger vehicles are provided.

The apparatus and methods may involve the use of two or more information items. Information items may be processed by an onboard processor. One or more of the information items may be generated by an unattended occupant protection system (“UOPS”) sensor. The UOPS sensor may be an original equipment manufacturer (“OEM”) sensor. The UOPS sensor may be an aftermarket sensor.

One or more of the information items may be sourced from a UOPS variable. A UOPS variable may include information relating to the presence and/or state of an unattended occupant. A UOPS variable may be provided by a UOPS sensor.

One or more of the items may be sourced from a vehicle operational variable. A vehicle operational variable may include information relating to operation and/or a state of the vehicle. A vehicle operational variable may include a vehicle navigation system variable. The vehicle operational variable may be provided by an OEM sensor or algorithm. The vehicle operation variable may be provided by an aftermarket sensor or algorithm.

One or more of the items may be sourced from a person variable. A person variable may include information about the location and/or state of a driver or passenger of the vehicle. A person variable may be provided by a vehicle driver or a mobile communication device. The vehicle driver may manually provide information. The mobile communication device may be associated with the driver or a passenger.

One or more of the UOPS variables, vehicle operational variables or person variables may be converted into metadata for use with a rules-based alarm decision processor.

The apparatus and methods may include storage and use of one or more profiles. The apparatus and methods may use a profile to determine one or more of: which data to collect, what UOPS machine-executable rules to apply, what alarm action to take and any other suitable course of action. Table 1 (below) shows illustrative profile categories.

TABLE 1
Illustrative profile categories
Profile Category

Driver
Driver age
Driver gender
Vehicle make
Vehicle year
Vehicle model
Vehicle Color
Travel type (commute, pleasure, extended)
Region of travel
Season

Table 2 (below) shows illustrative UOPS sensors and corresponding information.

TABLE 2
Illustrative UOPS sensors and corresponding information.

| | Location(s) | | | |
|---|---|---|---|---|
| UOPS | (interior of | | | |
| Sensor | vehicle) | Input Signal | Output Variable | UOPS Meta data |
| Infrared | Canopy, | Reception of | Relative thermal | Change over time in relative |
| | corner post, | thermal | radiation flux of | thermal radiation flux of |
| | side post, | radiation | target zone vs | target zone vs background |
| | back of seat | | background | |
| | (facing next | | | |
| | seat to aft), | | | |
| | door interior | | | |
| Optical - | Canopy, | Reception of | Relative intensity | Change over time in relative |
| active visual | corner post, | excitation | of reflected | intensity of reflected |
| spectrum | side post, | light | excitation light of | excitation light of target zone |
| detector | back of seat | reflection | target zone vs | vs background |
| | (facing next | | background. | |
| | seat to aft), | | | |
| | door interior | | | |
| Optical - | Canopy, | Reception of | Relative intensity | Change over time in relative |
| passive | corner post, | ambient light | of reflected light | intensity of reflected light of |
| visual | side post, | | of target zone vs | target zone vs background. |
| spectrum | back of seat | | background. | |
| detector | (facing next | | | |
| | seat to aft), | | | |
| | door interior | | | |
| Optical, | Canopy, | Object shape | Object shape | Non-vehicle shape detected |
| camera array | corner post, | in visual or | | Body part detected |
| | side post, | infrared | | Face detected |
| | back of seat | spectrum | | Eyes detected |
| | (facing next | | | Shape moved over time |
| | seat to aft), | | | Shape changed over time |
| | door interior | | | Shape present after door |
| | | | | open/close. |
| | | | | Shape detected among |
| | | | | multiple shapes |
| | | | | Shape detected among other |
| | | | | shapes and remains after |
| | | | | door open/close |
| Acoustic | Canopy, | 150-20,000 Hz | Presence of | Presence of (or change over |
| | corner post, | acoustic | sound, presence of | time in) human voice sound |
| | side post, | sampling; | sound in | Presence of (or change over |
| | back of seat | one or more | frequency band, | time in) guttural sound |
| | (facing next | different | presence of sound | Presence of (or change over |
| | seat to aft), | acoustic | statistically | time in) breathing sound |
| | door interior | receivers or | distinguishable | Presence of (or change over |
| | | microphones | from background | time in) animal sound |
| | | for frequency | sound; | Presence of (or change over |
| | | spectrum or | Difference | time in) material interaction |
| | | parts of | between interior | sound(fabric rustling, plastic |
| | | frequency | sound and | interactions, metal |
| | | spectrum | ambient sound | interactions) |
| | | | (exterior | |
| | | | microphone) | |
| | | | Acoustic signal | |
| | | | triangulated to | |
| | | | source in | |
| | | | passenger location | |
| Gravimetric | Driver seat | Pressure on | Pressure on seat | Change over time in seat |
| | Passenger seat | seat | Weight of object | pressure |
| | | | on seat | Change over time in object |
| | | | Areal extent of | weight |
| | | | object on seat | Change over time in extent |
| | | | | of object on seat |
| Capacitive | Driver seat | Matter on | Capacitance of | Change over time of |
| | Passenger seat | seat | object on seat | capacitance of object on seat |
| | | | AC conductivity | Change over time of AC |
| | | | of object on seat | conductivity of object on seat |
| | | | Areal extent of | Change over time of areal |
| | | | object on seat | extent of object on seat |
| Solar flux | Exterior | Intensity of | Radiative flux | Ambient radiative flux |
| | | solar | | (insolation) |
| | | radiation | | Change over time in radiative |
| | | | | flux |
| | | | | Average radiative flux over |
| | | | | preselected period |
| Temperature | Seat cushion | Temperature | Temperature | Temperature |
| | Seat back | | | Change over time of |
| | At interior of | | | temperature |
| | roof | | | Average temperature over |
| | Below interior | | | preselected period |
| | of roof | | | Difference in temperature |
| | Above interior | | | between different locations |
| | of floor | | | in vehicle |
| | | | | Difference in temperature |
| | | | | between seat component and |
| | | | | interior air temperature |

Table 3 (below) shows illustrative vehicle and person variables. Vehicle and person variables may be converted into metadata, which is not shown.

TABLE 3
Illustrative vehicle and person variables.
Vehicle/Person Variables

| | | Driver/Designated |
|---|---|---|
| | | Individual Variables |
| | Vehicle Navigation | (hand-held mobile |
| Vehicle Operational Variables | System Variables | communication device) |
| Lock status (locked/unlocked) | | |
| (door/window/trunk/hatch) | | |
| Door (ID, open, close) | Vehicle location | Short range communication |
| | | tether (RF, IR, Blue Tooth |
| | | (“BT”), WiFi) connected |
| Convertible top (open, closed) | | |
| Motor (on, off) | Driver location (from | Tether range |
| | wireless entry device, fob, | |
| | driver cell phone), ETA | |
| Fuel (supply low/medium/high) | Emergency services | Last known position |
| | locations, ETA | |
| Battery (charge low/medium/high) | Pre-selected location, | Vehicle monitoring app |
| | ETA | engaged |
| Window/sunroof (ID, open, close) | | |
| Collision prevention sensors | | |
| (proximity, velocity, frequency of | | |
| nearby vehicles) | | |
| Internal temperature | | |
| External temperature | | |
| Climate control system state | | |
| (thermostat setting, compressor | | |
| on/off, blower speed) | | |
| Time of day | | |
| Time elapsed after event | | |
| (driver door open/close, e.g.) | | |

One or more of the information items may be stored in machine-readable memory or broadcast periodically on a vehicle data bus. One or more of the variables may be stored in machine-readable memory or broadcast periodically on a vehicle data bus.

A processor in communication with the memory or the vehicle data bus or both may analyze an information item or a variable to determine whether it represents an alarm pre-condition in the context of a vehicle scenario. The processor may determine that the presence of two or more alarm pre-conditions requires activation of an alarm. A condition may relate to the likelihood of the presence of an unattended occupant. A condition may relate to the likelihood of injury to an unattended occupant.

Power for the apparatus and methods may be provided by a vehicle accessory power circuit. The circuit may be maintained in an energized state or in one or more different energized states. The energized state or states may provide sufficient power to operate UOPS sensors, vehicle operational variable sensors, vehicle navigation system sensors, processors, vehicle data bus controller and peripherals, and alert action devices. The energized states may include a monitor state, which may monitor for UOP. The energized state may include an alert state, which may launch an alert.

Data fusion may be the process, or part of the process, by which the UOPS safety systems determines whether to launch an equalization state. Data fusion may include analyzing data gathered by UOPS sensors, or any other suitable data source. A processor may use machine logic to make the determination based on the data. Illustrative data fusion use cases are set forth below.

Illustrative Use Case A

Illustrative use case A may include a summer scenario, with high solar insolation, and interior temperature rising over 3-minute period from driver exit.

Table 4 (below) shows an illustrative information item fusion matrix for the scenario.

TABLE 4
Illustrative information item fusion matrix.

| | Variable Values | | |
|---|---|---|---|
| Alarm pre-condition | YES | NO | UNKNOWN |
| UOPS State Variables | | | |
| A Warm body present | | | ✓ |
| B Reflective object present | | | ✓ |
| C Reflective object attitude change | ✓ | | |
| D Opaque object present | | | ✓ |
| E Non-vehicle shape present | ✓ | | |
| F Breathing sound present | | | ✓ |
| G Moving body sound present | | | ✓ |
| H Object present on seat | ✓ | | |
| I Low temperature condition present | | ✓ | |
| J High temperature condition present | ✓ | | |
| K Cooling condition present | | | ✓ |
| L Warming condition present | | | ✓ |
| M Solar radiation low | | ✓ | |
| N Solar radiation medium | | ✓ | |
| O Solar radiation high | ✓ | | |
| Vehicle Operational Variables | | | |
| Open door present | | ✓ | |
| Motor on | | ✓ | |
| Fuel supply low | | | ✓ |
| Open window present | | ✓ | |
| Cabin temperature low | | ✓ | |
| Cabin temperature medium | | ✓ | |
| Cabin temperature high | ✓ | | |
| Elapsed time (from door open + close): greater than 5 minutes | ✓ | | |
| Vehicle Navigation System Variables | | | |
| Vehicle location: distance from emergency services greater | | | ✓ |
| than 5 minutes | | | |
| Vehicle location: At pre-selected location | | | ✓ |
| Driver electronically tethered to vehicle | | | ✓ |
| Machine-executable logic | | | |
| Spectral reflectance spike suggests moving object. Presence | | | |
| of object corroborated by detection of non-vehicle shape. | | | |
| High solar radiation with rising interior temperature, | | | |
| suggesting dangerous condition. | | | |
| INITIATE ALARM ACTION (e.g., BASED ON MACHINE | ✓ | | |
| LOGIC)? | | | |

Illustrative Use Case B

Illustrative use case B may include a summer scenario, with low observed solar insolation, suggesting clouds, shade or night conditions, with interior temperature stable, and driver tethered.

Table 5 (below) shows an illustrative information item fusion matrix for the scenario.

TABLE 5
Illustrative information item fusion matrix

| | Variable Values | | |
|---|---|---|---|
| Alarm pre-condition | YES | NO | UNKNOWN |
| UOPS State Variables | | | |
| A Warm body present | | | ✓ |
| B Reflective object present | | | ✓ |
| C Reflective object attitude change | ✓ | | |
| D Opaque object present | | | ✓ |
| E Non-vehicle shape present | ✓ | | |
| F Breathing sound present | | | ✓ |
| G Moving body sound present | | | ✓ |
| H Object present on seat | ✓ | | |
| I Low temperature condition present | | | ✓ |
| J High temperature condition present | | | ✓ |
| K Cooling condition present | | ✓ | |
| L Warming condition present | | ✓ | |
| M Solar radiation low | ✓ | | |
| N Solar radiation medium | | ✓ | |
| O Solar radiation high | | ✓ | |
| Vehicle Operational Variables | | | |
| Open door present | | | ✓ |
| Motor on | | | ✓ |
| Fuel supply low | | | ✓ |
| Open window present | ✓ | | |
| Cabin temperature low | | | ✓ |
| Cabin temperature medium | ✓ | | |
| Cabin temperature high | | | ✓ |
| Elapsed time (from door open + close): greater than 5 minutes | | | ✓ |
| Vehicle Navigation System Variables | | | |
| Vehicle location: distance from emergency services greater | | | ✓ |
| than 5 minutes | | | |
| Vehicle location: At pre-selected location | | | ✓ |
| Driver electronically tethered to vehicle | ✓ | | |
| Machine-executable logic | | | |
| Spectral reflectance spike suggests moving object. Presence | | | |
| of object corroborated by detection of non-vehicle shape. | | | |
| Low solar radiation, stable medium range interior | | | |
| temperature, with corroborating UOPS and vehicle | | | |
| temperatures, and tethered driver suggest non-urgent | | | |
| condition. | | | |
| INITIATE ALARM ACTION (e.g., BASED ON MACHINE | | ✓ | |
| LOGIC)? | | | |

Illustrative Use Case C

Illustrative use case C may include a winter scenario, with low solar insolation, and interior temperature falling over 3-minute period from driver exit.

Table 6 (below) shows an illustrative information item fusion matrix for the scenario.

TABLE 6
Illustrative information item fusion matrix

| | Variable Values | | |
|---|---|---|---|
| Alarm pre-condition | YES | NO | UNKNOWN |
| UOPS State Variables | | | |
| A Warm body present | ✓ | | |
| B Reflective object present | | ✓ | |
| C Reflective object attitude change | | ✓ | |
| D Opaque object present | ✓ | | |
| E Non-vehicle shape present | | | ✓ |
| F Breathing sound present | | | ✓ |
| G Moving body sound present | | | ✓ |
| H Object present on seat | ✓ | | |
| I Low temperature condition present | ✓ | | |
| J High temperature condition present | | | ✓ |
| K Cooling condition present | ✓ | | |
| L Warming condition present | | ✓ | |
| M Solar radiation low | | ✓ | |
| N Solar radiation medium | | ✓ | |
| O Solar radiation high | ✓ | | |
| Vehicle Operational Variables | | | |
| Open door present | | | ✓ |
| Motor on | | ✓ | |
| Fuel supply low | | | ✓ |
| Open window present | | | ✓ |
| Cabin temperature low | ✓ | | |
| Cabin temperature medium | | ✓ | |
| Cabin temperature high | | ✓ | |
| Elapsed time (from door open + close): greater than 5 minutes | ✓ | | |
| Vehicle Navigation System Variables | | | |
| Vehicle location: distance from emergency services greater | | | ✓ |
| than 5 minutes | | | |
| Vehicle location: At pre-selected location | | | ✓ |
| Driver electronically tethered to vehicle | | | ✓ |
| Machine-executable logic | | | |
| Warm body present, object on seat; low temperature with | | | |
| cooling condition, vehicle motor off, and driver exit elapsed | | | |
| time greater than 5 minutes suggest possible danger condition, | | | |
| even though solar insolation is high. | | | |
| INITIATE ALARM ACTION (e.g., BASED ON MACHINE | ✓ | | |
| LOGIC)? | | | |

After reaching a decision to initiate an alarm action, the processor may launch one or more alarm action processes. Each process may include one or more alarm actions. Table 7 (below) shows illustrative alarm actions and priorities for one profile.

TABLE 7
Illustrative alarm actions and priorities for profile n.

| | Priority Tier |
|---|---|
| Alarm Action | (Profile n) |
| Lower window | 3 |
| Lock window | 4 |
| Unlock widow | 4 |
| Lock door | 4 |
| Unlock door | 3 |
| Open hatch door | 4 |
| Sound vehicle horn | 2 |
| Engage vehicle speaker/annunciator to announce alarm | 3 |
| Flash vehicle head lights | 2 |
| Flash exterior alert light (standardized UOPS color, form factor) | 2 |
| Contact user(s) from user list (cell, landline, email, text, Instagram, etc.) | 1 |
| Contact emergency services (possibly dependent upon interior | 3 |
| temperature) | |
| Notify parking attendant/security patrol | 2 |
| Buzz-back or signal to remote key or fob (initially, if object | 1 |
| registered prior to travel and not removed after driver door | |
| open/close, and then follow-up if dynamic/motion signal received). | |
| Turn on motor (e.g., by activating remote start) and use climate | 4 |
| control system to keep interior with acceptable temperature limits | |
| (monitor fuel, broadcast predicted run-time). | |
| Navigate to default or preselected destination, such as one or more of | 5 |
| those identified in Navigation System Variables, Table 3, above. | |
| Provide ETA by phone, text, email, public or private secure or non- | |
| secure WAN or LAN, etc., to one or more of driver, preselected | |
| entities, public safety representative, hospital, etc. | |

Communication between the UOPS system and a party outside the vehicle may be performed via a mobile communication device tethered to the phone. Communication between the UOPS system and a party outside the vehicle may be performed via an on-board telematic system. Communication between the UOPS system and a party outside the vehicle may be performed via an aftermarket telecommunication device. mobile communication device tethered to the phone.

The party may be a custom selected party. The UOPS may be preprogrammed to engage a stored telephone number of the party. The party may be a party that provides further communication to emergency services.

The UOPS may establish an audio feed from the vehicle to the party or emergency services. The UOPS may establish a video feed from the vehicle to the party or emergency services.

Each alarm action may be assigned a priority tier. Each priority tier may include one or more alarm actions. The processor may initiate alarm actions in a sequence, such as by initiating one or more alarm actions from Tier 1, then one or more alarm actions from Tier 2, Tier m, etc. The assignment of alarm actions to different tiers may be different for each profile. Tiers for Profile n are identified in Table 7 as an example.

The processor may provide an alarm instruction to an alarm system. The alarm system may be separate from the UOPS module. The alarm system may be separate from the UOPS safety system. The alarm system may initiate the alarm action. The alarm system may be programmable to select an alarm action. The instruction may include one or more parameters. The one or more parameters may include one or more alarm pre-conditions. The alarm system may read the one or more parameters. The alarm system may select an alarm action based on the presence or absence of one or more of the alarm parameters. The processor may output the instruction to a vehicle data bus.

An aftermarket safety system for passenger vehicles is provided. The safety system may include a plurality of unattended occupant protection system (UOPS) sensors. The plurality of UOPS sensors may include a first set of UOPS sensors, a second set of UOPS sensors, and a third set of UOPS sensors.

The safety system may include a module. A module may be alternatively referred to herein as a UOPS module. The module may include a processor and a non-transitory machine-readable memory for storing data detected by the UOPS sensors. The memory may also store machine-executable instructions. The machine-executable instructions may provide logic for the processor to run at least a part of the UOPS safety system.

The first set of UOPS sensors may be for positioning relative to a passenger's seat of the passenger vehicle. The second set of UOPS sensors may be for positioning relative to a driver's seat of the passenger vehicle. The third set of UOPS sensors may include a temperature sensor for detecting a temperature in the passenger vehicle. The third set of UOPS sensors may be for positioning in any suitable location in the passenger vehicle.

The module may be for installation in the passenger vehicle. In some embodiments, the module may include components that are removable from the vehicle. In certain embodiments, the module may include a mobile phone. The mobile phone may include a UOPS application.

The module may be configured to communicate with the plurality of UOPS sensors. The module may also be configured to integrate with a vehicle data bus. Integration with a vehicle data bus may enable the module to communicate with and/or control some or all of the components of the passenger vehicle.

The safety system may be configured to draw power from a battery of the passenger car even when the passenger car is in an off state. In some embodiments, the safety system may include a power source independent of the passenger vehicle battery. The independent power source may be a battery. The independent power source may include solar power.

The safety system may be configured to be in a monitor state. The monitor state may be the default state of the safety system. In some embodiments, the monitor state may be activated manually. In certain embodiments, the monitor state may be activated automatically when the passenger vehicle is in park.

In a monitor state, the plurality of UOPS sensors may periodically or substantially continuously update data in the memory and/or vehicle data bus. When the processor determines that an unattended occupant is present with an unsafe environment, the processor may launch an equalization mode.

The processor's determination of the presence of an unattended occupant in an unsafe environment may follow the confluence of multiple factors. For example, a first set of UOPS sensors may detect a physical presence of a passenger sitting in the passenger's seat of the passenger vehicle. A second set of UOPS sensors may detect an absence of the driver sitting in the driver's seat of the passenger vehicle. A third set of UOPS sensors may detect either an unsafe temperature in the passenger vehicle, or a delta in the temperature in the passenger vehicle over a three-minute timespan. Based on detection of these three events, the processor may launch an equalization mode.

An unsafe temperature may include a temperature that is outside of a safe range. A safe range may be from 65 to 80 degrees Fahrenheit. A safe range may be any other suitable range of temperatures. A safe range may be based on a location of the vehicle.

In an equalization mode, the processor may stabilize the temperature in the passenger vehicle to within the range from 65 to 80 degrees Fahrenheit. The processor may accomplish this by providing power to one or more vehicle components. The processor may take control of one or more vehicle components. For example, the processor may open one or more windows, sunroofs, doors and/or hatches of the passenger vehicle. The processor may activate a climate control of the vehicle. The processor may direct the opening and/or activating over the vehicle data bus.

In some embodiments, the processor in an equalization mode may direct all the resources at its disposal to bring the temperature to within the range from 65 to 80 degrees Fahrenheit as quickly as possible. Once that is accomplished, the processor may use only some or part of the resources to maintain the temperature in the range. For example, the processor may detect a temperature in the vehicle of 100 degrees Fahrenheit. The processor may then launch an equalization mode and open all the passenger vehicle windows and also turn on the air conditioner to a maximum setting. When the temperature in the vehicle is lowered to 72 degrees, the processor may turn off the air conditioner and leave only two windows open. This may be sufficient to maintain the temperature within the range.

In some embodiments, the safety system may include equalization devices for equalizing the temperature. Equalization device may include water or mist sprinklers, fans, and heat emitting devices.

In certain embodiments of the safety system, at least one of the second set of UOPS sensors may be a capacitive sensor for detecting capacitance on the driver's seat. The processor's determination that the capacitive sensor detects the absence of a driver sitting in the driver's seat may be responsive to a delta in the detected capacitance on the driver's seat.

In some embodiments, the safety system may further include at least a first vehicle operational sensor. The first vehicle operational sensor may be for detecting an opening event and a closing event of a driver's door of the passenger vehicle. In this embodiment, the processor's determination that the second set of UOPS sensors detects the absence of a driver sitting in the driver's seat includes a detection of an absence that occurs after an opening event of the driver's door and before a closing event of the driver's door.

In certain embodiments of the safety system, at least one of the second set of UOPS sensors may be a camera array for detecting images. The camera array may include a video camera. The processor's determination that the camera array detects the absence of a driver sitting in the driver's seat may be responsive to images and/or video associated with an empty driver's seat. The processor may employ image processing, computer vision, artificial intelligence (AI) and/or machine learning (ML) techniques to assist in the determination.

In some embodiments of the safety system, at least one of the first set of UOPS sensors may be a capacitive sensor for detecting capacitance on the passenger's seat. The processor's determination that the capacitive sensor detects the physical presence of a passenger sitting in the passenger's seat may be responsive to a level of detected capacitance on the passenger's seat that is greater than the typical capacitance detected on the passenger seat when the passenger car is in an off state. The typical capacitance detected on the passenger seat when the passenger car is in an off state may include capacitance due to a seat cover or a protective car seat. The processor's determination may also be responsive to a fluctuation in the capacitive patterns, which may indicate movement on the passenger's seat.

In certain embodiments of the safety system, at least one of the first set of UOPS sensors may be a gravimetric sensor for detecting a pressure on the passenger's seat. The gravimetric sensor may include an occupant classification system (OCS). The processor's determination that the gravimetric sensor detects the physical presence of a passenger sitting in the passenger's seat may be responsive to a level of detected pressure on the passenger's seat that is greater than the typical pressure detected on the passenger seat when the passenger car is in an off state. The typical capacitance pressure on the passenger seat when the passenger car is in an off state may include pressure due to a seat cover or a protective car seat. The processor's determination may also be responsive to a fluctuation in the detected pressure, which may indicate movement on the passenger's seat.

In some embodiments of the safety system, at least one of the first set of UOPS sensors may be an infrared sensor for detecting thermal radiation emanating from a region on the passenger's seat. The infrared sensor may be installed at a canopy, corner post, side post, door interior, and/or rear of a front row seat of the passenger vehicle. The processor's determination that the infrared sensor detects the physical presence of a passenger sitting in the passenger's seat may be responsive to a delta in relative thermal radiation flux of the region on the passenger's seat versus a background of the passenger vehicle.

In certain embodiments of the safety system, at least one of the first set of UOPS sensors may be an acoustic sensor for detecting sound. The processor's determination that the acoustic sensor detects the physical presence of a passenger sitting in the passenger's seat may be responsive to a pattern of sound associated with human voice, human crying, human breathing, or any other suitable pattern indicative of a human presence.

In some embodiments of the safety system, at least one of the first set of UOPS sensors may be an optical sensor for detecting light. The optical sensor may be an optical-active visual spectrum detector or an optical-passive visual spectrum detector. The processor's determination that the optical sensor detects the physical presence of a passenger sitting in the passenger's seat, may be responsive to a pattern of detected light that is associated with movement of a human sitting in the passenger's seat.

In certain embodiments of the safety system, at least one of the first set of UOPS sensors may be a camera array for detecting images. The processor's determination that the camera array detects the physical presence of a passenger sitting in the passenger's seat may be responsive to images associated with a human sitting in the passenger's seat.

In some embodiments, the safety system may be configured to be in a monitor state when a transmission of the passenger vehicle is set to a park mode. In certain embodiments, the safety system may be configured to exit an equalization mode when the transmission is removed from a park mode. In some embodiments, a predesignated driver may manually exit an equalization mode.

In certain embodiments, the safety system may further comprise a UOPS alert horn and a UOPS alert beacon for positioning on an exterior of the passenger vehicle. The equalization mode may further include sounding the UOPS alert horn and flashing the UOPS alert beacon.

In some embodiments of the safety system, the equalization mode may further include the processor directing the passenger vehicle to drive autonomously to the nearest location from a list including a hospital, police station, and fire station. The direction may include communication over the integrated vehicle data bus.

In some embodiments of the safety system, the module may include a connection to a communication network. The module may have a connection to a cellular communication network. The module may have a connection to the internet. The connection may be accomplished via a communication component native to the module. In some embodiments, the connection may be via the integration with the vehicle data bus of the passenger vehicle, and a component of the passenger vehicle may be connected to a communication network. In an equalization mode, the module may send an emergency message to a predesignated driver and emergency services. The sending may be accomplished directly, or indirectly via the integrated vehicle data bus.

A passenger vehicle configured with an unattended occupant protection system (UOPS) is provided. The passenger vehicle may include a plurality of UOPS sensors. The UOPS sensors may include at least a first, second, and third set of UOPS sensors. The first set of UOPS sensors may be for detecting a physical presence of a passenger sitting in a passenger's seat of the passenger vehicle. The second set of UOPS sensors may be for detecting an absence of a driver sitting in a driver's seat of the passenger vehicle. The third set of UOPS sensors may be for detecting a temperature in the passenger vehicle. The third set of UOPS sensors may include a temperature sensor.

The passenger vehicle may include a non-transitory machine-readable memory for storing data detected by the UOPS sensors. The passenger vehicle may also include a vehicle data bus for broadcasting data detected by the UOPS sensors. The passenger vehicle may include a processor in communication with the memory and/or vehicle data bus.

The passenger vehicle may be configured to be in a monitor state. In a monitor state, the plurality of UOPS sensors may periodically or substantially continuously update data in the memory and/or vehicle data bus. When the processor determines that: the first set of UOPS sensors detect a physical presence of a passenger sitting in the passenger's seat of the passenger vehicle; the second set of UOPS sensors detect an absence of the driver sitting in the driver's seat of the passenger vehicle; and the third set of UOPS sensors detect either a temperature in the passenger vehicle that is outside of the range from 65 to 80 degrees Fahrenheit, or a delta in the temperature in the passenger vehicle over a three-minute timespan; the processor may launch an equalization mode. An equalization mode may stabilize the temperature in the passenger vehicle to within the range from 65 to 80 degrees Fahrenheit. The equalization mode may open one or more windows, sunroofs, doors and/or hatches of the passenger vehicle. The equalization mode may activate a climate control of the vehicle.

In some embodiments of the passenger vehicle, at least one of the second set of UOPS sensors may be a gravimetric sensor for detecting a pressure on the driver's seat. The processor's determination that the gravimetric sensor detects the absence of a driver sitting in the driver's seat may be responsive to a delta in the detected pressure on the driver's seat.

In certain embodiments of the passenger vehicle, at least one of the first set of UOPS sensors may be an infrared sensor for detecting thermal radiation emanating from a region on the passenger's seat. The infrared sensor may be installed at a canopy, corner post, side post, door interior, and/or rear of a front row seat of the passenger vehicle. The processor's determination that the infrared sensor detects the physical presence of a passenger sitting in the passenger's seat may be responsive to a delta in relative thermal radiation flux of the region on the passenger's seat versus a background of the passenger vehicle.

In some embodiments of the passenger vehicle, at least one sensor of the first or second sets of UOPS sensors may be an optical sensor for detecting light. The optical sensor may be an optical-active visual spectrum detector. The optical-active visual spectrum detector may stimulate excitation of particles to detect. The optical sensor may be an optical-passive visual spectrum detector. The optical sensor may be a camera array. The processor's determination that the optical sensor detects the physical presence of a passenger sitting in the passenger's seat, or detects the absence of a driver sitting in the driver's seat, may be responsive to a pattern of detected light that is associated with a human sitting in the passenger's seat or an empty driver's seat.

In some embodiments, the passenger vehicle may be configured to be in a monitor state when a transmission of the passenger vehicle is set to a park mode.

A method for equalizing the ambient temperature in a passenger vehicle using an unattended occupant protection system (UOPS) safety system is provided. The UOPS safety system may include a first set of UOPS sensors installed relative to a passenger's seat of the passenger vehicle. The UOPS safety system may also include a second set of UOPS sensors installed relative to a driver's seat of the passenger vehicle. The UOPS safety system may also include a third set of UOPS sensors installed in the passenger vehicle for detecting the ambient temperature. The third set of UOPS sensors may include a temperature sensor.

The UOPS safety system may include a UOPS module. The UOPS module may be installed in the passenger vehicle. The UOPS module may be a mobile phone. The UOPS module may include a processor. The UOPS module may include a non-transitory machine-readable memory for storing data detected by the UOPS sensors.

The UOPS module may be configured to communicate with the UOPS sensors. The UOPS module may be configured to integrate with a vehicle data bus.

The method may include toggling the UOPS module to be in a monitor state. The monitor state may include the plurality of UOPS sensors periodically or substantially continuously updating data in the memory and/or vehicle data bus.

The method may include the processor launching an equalization mode upon determination of three events. First, the first set of UOPS sensors detecting a physical presence of a passenger sitting in the passenger's seat of the passenger vehicle. Second, the second set of UOPS sensors detecting an absence of a driver sitting in the driver's seat of the passenger vehicle. Third, the third set of UOPS sensors detecting either a temperature in the passenger vehicle that is outside of a range from 65 to 80 degrees Fahrenheit, or a delta in a temperature in the passenger vehicle over a three-minute timespan.

The equalization mode may include the processor stabilizing the temperature in the passenger vehicle to within the range from 65 to 80 degrees Fahrenheit. The processor may accomplish this by opening one or more windows, sunroofs, doors and/or hatches of the passenger vehicle, and/or activating a climate control of the vehicle. The processor may direct the opening and/or activating via communication with the vehicle data bus with which the processor may be integrated.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

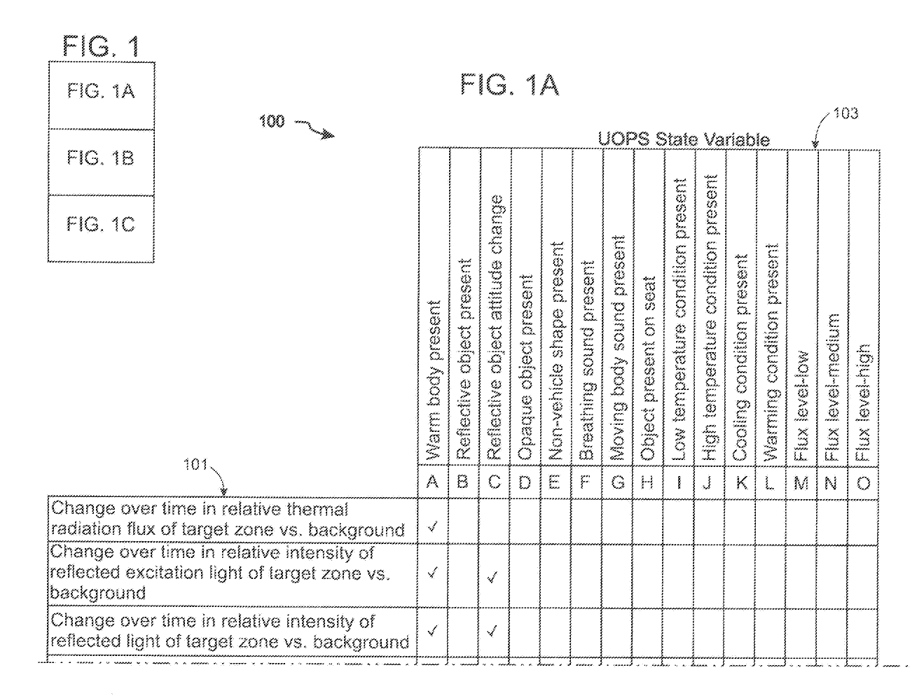

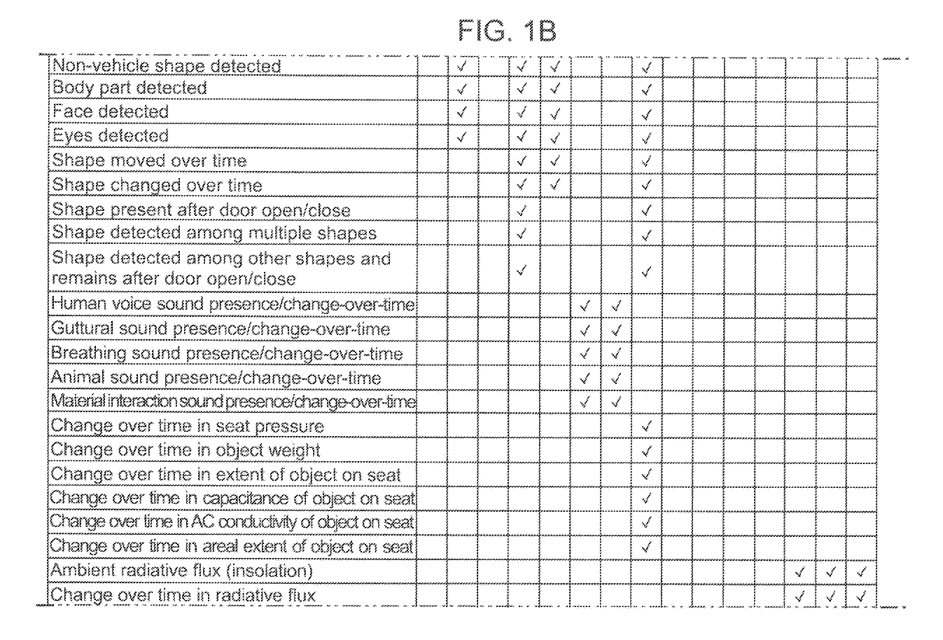

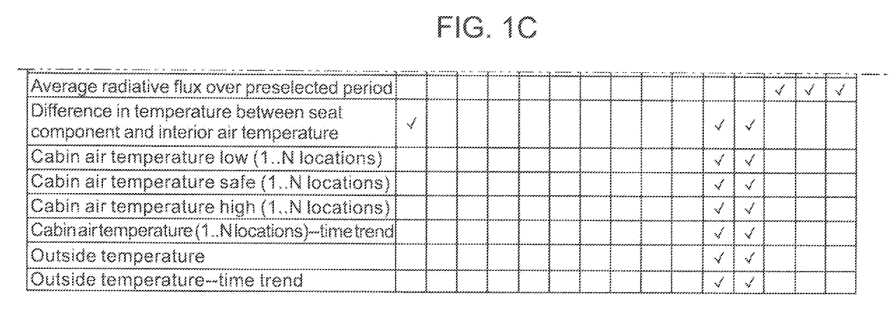

FIG. 1 shows illustrative information 100. FIG. 1 includes FIG. 1A, FIG. 1B, and FIG. 1C. Information 100 shows an illustrative correspondence matrix between UOPS metadata 101 and UOPS state variables 103. The UOPS state variables may be defined based on one or more corresponding UOPS metadata values. The UOPS state variables may be defined in such a way as to serve as input to a rules engine that is configured to determine whether an alarm precondition is present.

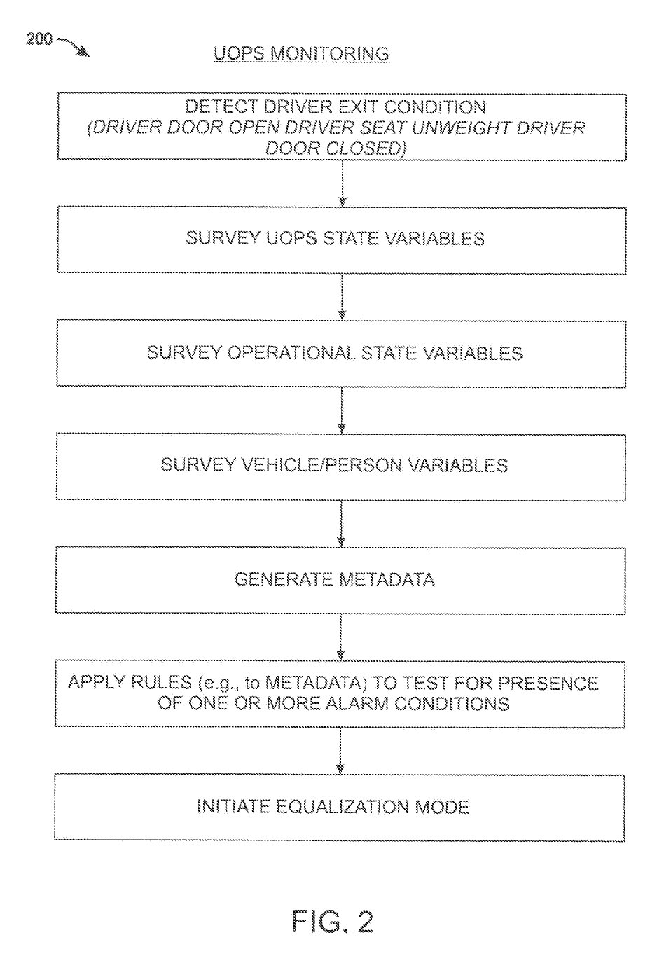

FIG. 2 shows illustrative flowchart 200. Flowchart 200 represents steps of a procedure for fusing data in conformance with the principles of the disclosure.

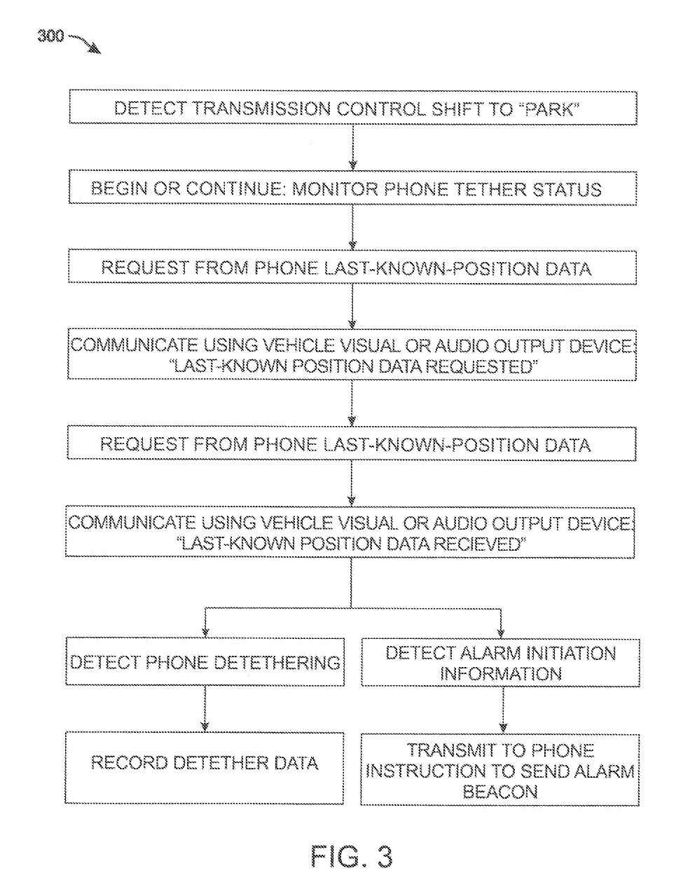

FIG. 3 shows illustrative flowchart 300. Flowchart 300 represents steps of a method for monitoring the last known position of a driver or designated person. The position may be recorded in response to a shift of a transmission control into the “Park” position. The position may be recorded in response to a detection of a detethering from the vehicle of a mobile communication device.

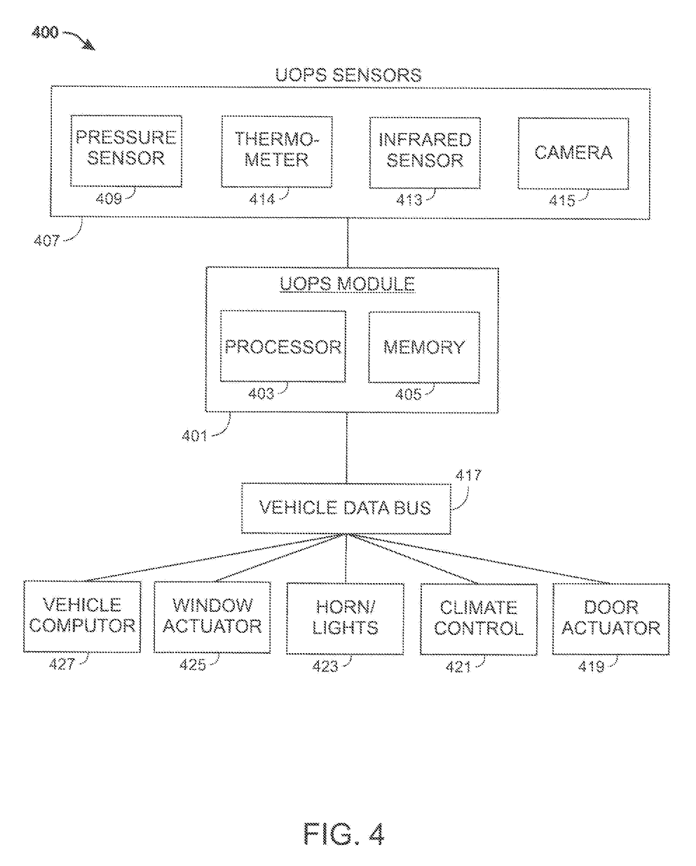

FIG. 4 shows illustrative system 400. System 400 represents an integrated UOPS safety system. UOPS module 401 may contain processor 403 and memory 405. UOPS module may be connected to, or otherwise in communication with, UOPS sensors 407. UOPS sensors 407 may include at least one pressure sensor 409, at least one thermometer 411, at least one infrared sensor 413, and/or at least one camera 415.

UOPS module 410 may be connected to, or otherwise integrated with, vehicle data bus 417. Vehicle data bus 417 may be connected to, or otherwise in communication with, a plurality of components. The components may include at least one door actuator 419, climate control 421, horn/lights 423, at least one window actuator 425, and/or vehicle computer 427.

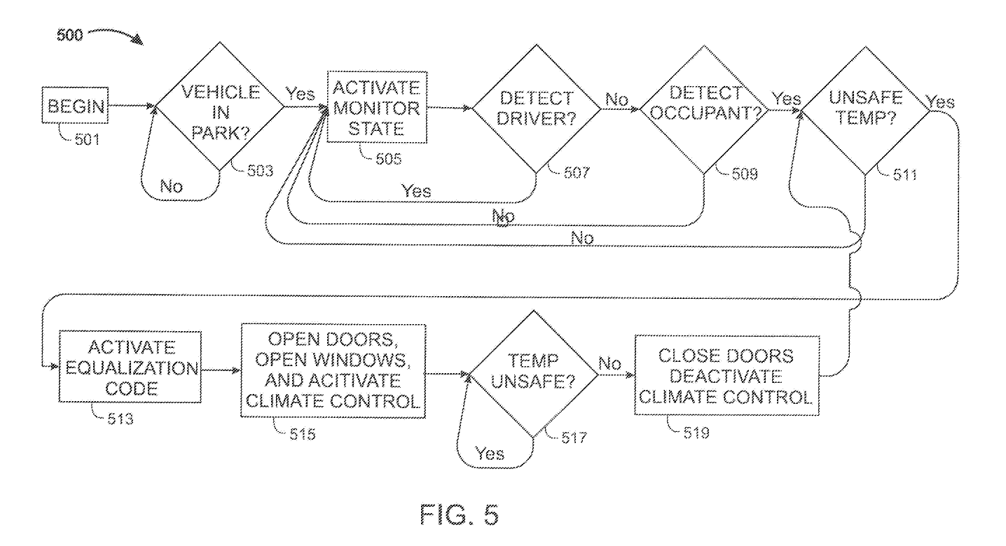

FIG. 5 shows illustrative flowchart 500. Flowchart 500 represents steps of a method for equalizing ambient temperature with a UOPS safety system.

Flowchart 500 begins at step 501. At step 503, the method checks whether the vehicle is in park. If the vehicle is not in park, the method periodically or substantially continuously revisits step 503. If the vehicle is in park, the method proceeds to step 505 and a monitor state is activated. In the monitor state, the method periodically or substantially continuously proceeds to step 507 and checks whether a driver is detected. If yes, the method revisits step 505. If not, the method proceeds to step 509, which queries whether an occupant is detected. If not, the method returns to step 505. If yes, the method proceeds to step 511, which queries whether an unsafe temperature is detected. If not, the method returns to step 505. If yes, the method proceeds to step 513, and launches an equalization mode. In the equalization mode, the method proceeds to step 515 and opens doors and windows, and activates a climate control of the passenger vehicle. The method then proceeds to step 517, which queries whether an unsafe temperature is still detected. If yes, the method periodically or substantially continuously revisits step 517. If not, the method proceeds to step 519. At step 519 the method closes the doors and deactivates the climate control, while leaving open the windows to maintain the safe temperature. The method then periodically or substantially continuously returns to step 511 and for an unsafe temperature.

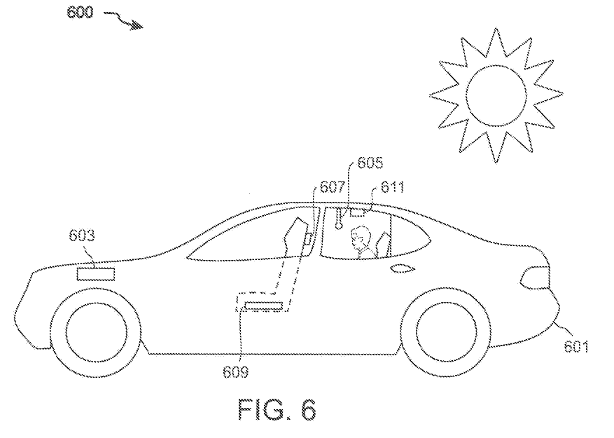

FIG. 6 shows illustrative system 600. System 600 includes a passenger vehicle 601. System 600 may include UOPS module 603. UOPS module 603 may be integrated with components of passenger vehicle 601. For example, UOPS module 603 may be installed in an engine compartment of passenger vehicle 601. In another embodiment (not shown), UOPS module may be installed in a dashboard or a trunk compartment of passenger vehicle 601.

System 600 may include a thermometer 605. Thermometer 605 may be installed at a ceiling of passenger vehicle 601.

System 600 may also include a UOPS sensor 607. UOPS sensor 607 may be installed in or on the rear of a front row seat, facing a rear passenger's seat. UOPS sensor 607 may be able to detect the presence of a passenger in the passenger's seat. In one example, UOPS sensor 607 may be a camera. In another example, UOPS sensor 607 may be an infrared sensor or any other suitable sensor.

System 600 may also include a UOPS sensor 609. UOPS sensor 609 may be installed in or on the driver's seat of the passenger vehicle. UOPS sensor 609 may be able to detect the presence of a driver in the driver's seat. In one example, UOPS sensor 607 may be a pressure sensor. In another example, UOPS sensor 607 may be a capacitive sensor or any other suitable sensor.

System 600 may also include an equalization device 611. Equalization device 611 may be installed at the ceiling of the passenger vehicle above the passenger's seat. Equalization device 611 may be able to stabilize a temperature in the passenger vehicle. In one example, equalization device 611 may be a fan. In another example, equalization device 611 may be a mist emitter or any other suitable device.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for unattended occupant protection systems for ambient temperature equalization are provided. Persons skilled in the art will appreciate that the present invention can be practiced by other than the described embodiments, which are presented for purposes of illustration rather than of limitation, and that the present invention is limited only by the claims that follow.

What is claimed is:

1. An aftermarket safety system for passenger vehicles, said safety system comprising:
a plurality of unattended occupant protection system (UOPS) sensors, including a first set of UOPS sensors, a second set of UOPS sensors, and a third set of UOPS sensors; and
a module, said module including a processor and a non-transitory machine-readable memory for storing data detected by the UOPS sensors;
wherein:
the first set of UOPS sensors is configured to monitor a passenger's seat of the passenger vehicle;
the second set of UOPS sensors is configured to monitor a driver's seat of the passenger vehicle;
the third set of UOPS sensors includes a temperature sensor, and is configured to monitor temperature in the passenger vehicle;
the module is configured to communicate with the plurality of UOPS sensors and integrate with a vehicle data bus;
the safety system is configured to draw power from a battery of the passenger vehicle even when the passenger vehicle is in an off state;
wherein:
the plurality of UOPS sensors periodically or substantially continuously update data in the memory and/or vehicle data bus:
in response to the processor of the module determining that:
the first set of UOPS sensors detect a physical presence of a passenger sitting in the passenger's seat of the passenger vehicle;
the second set of UOPS sensors detect an absence of the driver sitting in the driver's seat of the passenger vehicle; and
the third set of UOPS sensors detect either a temperature in the passenger vehicle that is outside of a range from 65 to 80 degrees Fahrenheit, or a delta in the temperature in the passenger vehicle over a three-minute timespan;
the processor is configured to launch an equalization mode that stabilizes the temperature in the passenger vehicle to within the range from 65 to 80 degrees Fahrenheit by activating the vehicle data bus and controlling operation of otherwise dormant vehicle sub-systems to:
open one or more windows, sunroofs, doors and/or hatches of the passenger vehicle, and/or
activate a climate control system of the passenger vehicle.

2. The safety system of claim 1, wherein at least one of the second set of UOPS sensors is a capacitive sensor for detecting capacitance on the driver's seat, and wherein the processor's determination that the capacitive sensor detects the absence of a driver sitting in the driver's seat is responsive to a change in detected capacitance on the driver's seat.

3. The safety system of claim 1, further comprising at least a first vehicle operational sensor, the first vehicle operational sensor configured to detect an opening event and a closing event of a driver's door of the passenger vehicle;
wherein at least one of the second set of UOPS sensors is a capacitive sensor for detecting capacitance on the driver's seat; and
wherein the processor's determination that the capacitive sensor detects the absence of a driver sitting in the driver's seat is responsive to a change in detected capacitance on the driver's seat that occurs after an opening event of the driver's door and before a closing event of the driver's door.

4. The safety system of claim 1, wherein at least one of the second set of UOPS sensors is a camera array for detecting images, and wherein the processor's determination that the camera array detects the absence of a driver sitting in the driver's seat is responsive to images associated with an empty driver's seat.

5. The safety system of claim 1, wherein at least one of the first set of UOPS sensors is a capacitive sensor for detecting capacitance on the passenger's seat, and wherein the processor's determination that the capacitive sensor detects the physical presence of a passenger sitting in the passenger's seat is responsive to a level of detected capacitance on the passenger's seat that is greater than a historical capacitance associated with the passenger seat when an engine of the passenger vehicle is off.

6. The safety system of claim 1, wherein at least one of the first set of UOPS sensors is a gravimetric sensor for detecting a pressure on the passenger's seat, and wherein the processor's determination that the gravimetric sensor detects the physical presence of a passenger sitting in the passenger's seat is responsive to a level of detected pressure on the passenger's seat that is greater than the typical pressure detected on the passenger seat when an engine of the passenger vehicle is off.

7. The safety system of claim 1, wherein at least one of the first set of UOPS sensors is an infrared sensor for detecting thermal radiation emanating from a region on the passenger's seat, said infrared sensor being installed at a canopy, corner post, side post, door interior, and/or rear of a front row seat of the passenger vehicle, and wherein the processor's determination that the infrared sensor detects the physical presence of a passenger sitting in the passenger's seat is responsive to a change in relative thermal radiation flux of the region on the passenger's seat versus thermal radiation flux of a non-seating area of the passenger vehicle.

8. The safety system of claim 1, wherein at least one of the first set of UOPS sensors is an acoustic sensor for detecting sound, and wherein the processor's determination that the acoustic sensor detects the physical presence of a passenger sitting in the passenger's seat is responsive to a pattern of sound associated with human voice, human crying, or human breathing.

9. The safety system of claim 1, wherein at least one of the first set of UOPS sensors is an optical sensor for detecting light, the optical sensor being an optical-active visual spectrum detector or an optical-passive visual spectrum detector, and wherein the processor's determination that the optical sensor detects the physical presence of a passenger sitting in the passenger's seat, is responsive to a pattern of detected light that is associated with movement of a human sitting in the passenger's seat.

10. The safety system of claim 1, wherein at least one of the first set of UOPS sensors is a camera array for detecting images, and wherein the processor's determination that the camera array detects the physical presence of a passenger sitting in the passenger's seat is responsive to images associated with a human sitting in the passenger's seat.

11. The safety system of claim 1, wherein the safety system is configured to substantially continuously gather data from the first, second and third sets of UOPS sensors when a transmission of the passenger vehicle is set to a park mode, and wherein the safety system is configured to exit an equalization mode when the transmission is removed from a park mode.

12. The safety system of claim 1, further comprising a UOPS alert horn and a UOPS alert beacon configured to be installed on an exterior of the passenger vehicle, wherein in the equalization mode, the processor is configured to sound the UOPS alert horn and flashing the UOPS alert beacon.

13. The safety system of claim 1, wherein, in the equalization mode the processor is configured to take control of a plurality of vehicle sub-systems and drive the passenger vehicle autonomously to the nearest location from a list including a hospital, police station, and fire station.

14. The safety system of claim 1, wherein the module comprises a connection to a communication network, and, in an equalization mode, the processor is configured to send an emergency message to a predesignated driver and emergency services.

15. A passenger vehicle configured with an unattended occupant protection system (UOPS), said passenger vehicle comprising:
a plurality of UOPS sensors, the UOPS sensors including at least:
a first set of UOPS sensors for detecting a physical presence of a passenger sitting in a passenger's seat of the passenger vehicle;
a second set of UOPS sensors for detecting an absence of a driver sitting in a driver's seat of the passenger vehicle; and
a third set of UOPS sensors, including a temperature sensor, for detecting a temperature in the passenger vehicle;
a non-transitory machine-readable memory for storing data gathered by the UOPS sensors;
a vehicle data bus for broadcasting the data gathered by the UOPS sensors; and
a processor in communication with the memory and vehicle data bus;
wherein:
the passenger vehicle is configured to have a monitor state wherein the plurality of UOPS sensors periodically or substantially continuously gather data; and
the processor places the vehicle in an equalization mode in response to:
the first set of UOPS sensors detecting a physical presence of a passenger sitting in the passenger's seat of the passenger vehicle;
the second set of UOPS sensors detecting an absence of the driver sitting in the driver's seat of the passenger vehicle; and
the third set of UOPS sensors detecting a temperature in the passenger vehicle that is outside of a range from 65 to 80 degrees Fahrenheit, or a change in the temperature in the passenger vehicle over a three-minute timespan; and
wherein, the equalization mode is configured to stabilize the temperature in the passenger vehicle to within the range from 65 to 80 degrees Fahrenheit by opening one or more windows, sunroofs, doors and/or hatches of the passenger vehicle, and/or activating a climate control of the vehicle.

16. The passenger vehicle of claim 15, wherein at least one of the second set of UOPS sensors is a gravimetric sensor for detecting a pressure on the driver's seat, and wherein the processor's determination that the gravimetric sensor detects the absence of a driver sitting in the driver's seat is responsive to a change in the detected pressure on the driver's seat.

17. The passenger vehicle of claim 15:
wherein at least one of the first set of UOPS sensors is an infrared sensor for detecting thermal radiation emanating from a seating area of the passenger vehicle, said infrared sensor being installed at a canopy, corner post, side post, door interior, and/or rear of a front row seat of the passenger vehicle; and
wherein the processor is configured to determine that the infrared sensor detects the physical presence of a passenger sitting in the passenger's seat based on a change in relative thermal radiation flux of the seating area versus a background another area of the passenger vehicle.

18. The passenger vehicle of claim 15:
wherein at least one sensor of the first or second sets of UOPS sensors is an optical sensor for detecting light, the optical sensor being an optical-active visual spectrum detector, an optical-passive visual spectrum detector, or an optical camera array; and
wherein the processor is configured to determine that the optical sensor detects the physical presence of a passenger sitting in the passenger's seat, or detects the absence of a driver sitting in the driver's seat based on detecting a pattern of detected light that is associated with a human sitting in the passenger's seat.

19. The passenger vehicle of claim 15, wherein the passenger vehicle is configured to be in the monitor state when a transmission of the passenger vehicle is set to a park mode.

20. A method for equalizing the ambient temperature in a passenger vehicle using an unattended occupant protection system (UOPS) safety system, the method comprising:
in a monitor state, periodically or substantially continuously gathering data from a plurality of UOPS sensors installed in the passenger vehicle;
launching an equalization mode in response to determining that:
a first subset of the UOPS sensors detect a physical presence of a passenger sitting in the passenger's seat of the passenger vehicle;
a second sub set of the UOPS sensors detect an absence of a driver sitting in the driver's seat of the passenger vehicle; and
a third subset of the UOPS sensors detect a temperature in the passenger vehicle that is outside of a range from 65 to 80 degrees Fahrenheit, or a change in a temperature in the passenger vehicle over a three-minute timespan;
in response to launching the equalization mode stabilizing the temperature in the passenger vehicle to within the range from 65 to 80 degrees Fahrenheit by activating a dormant vehicle data bus and issuing commands via the vehicle data bus that open one or more windows, sunroofs, doors and/or hatches of the passenger vehicle, and/or activate a climate control of the vehicle.
